(19) United States
(12) Patent Application Publication
(10) Pub. No.: US 2026/0188905 A1
(43) Pub. Date: Jul. 2, 2026

(54) ANTENNA DEVICE

(71) Applicant: AGC Inc., Tokyo (JP)

(72) Inventors: Shoichi TAKEUCHI, Tokyo (JP); Kazuya MATSUMOTO, Tokyo (JP); Hideaki SHOJI, Tokyo (JP); Yusuke KATO, Tokyo (JP); Naoki HASHIMOTO, Tokyo (JP); Shimpei TOMIDA, Tokyo (JP)

(73) Assignee: AGC Inc., Tokyo (JP)

(21) Appl. No.: 19/551,036

(22) Filed: Feb. 26, 2026

Related U.S. Application Data
(63) Continuation of application No. PCT/JP2024/029269, filed on Aug. 19, 2024.

(30) Foreign Application Priority Data
Aug. 28, 2023 (JP) 2023-137890

(51) Int. Cl. H01Q 9/04

(52) U.S. Cl. CPC H01Q 9/0407

(57) ABSTRACT

An antenna device, including: a dielectric plate having a first surface provided with a radiation conductor and a second surface opposite to the first surface; a conductive layer provided on the dielectric plate; and a feeding structure for feeding the radiation conductor, wherein when a wavelength of a radio wave transmitted or received by the radiation conductor in air is λ, and a wavelength shortening rate by the dielectric plate is k, the conductive layer has an inner edge surrounding the radiation conductor such that a gap exists between the inner edge and an outer edge of the radiation conductor in plan view of the dielectric plate, a size of the outer edge of the radiation conductor and a size of the inner edge of the conductive layer are limited by λ and k.

### INCORPORATION BY REFERENCE

This application is based upon and claims the benefit of priority from Japanese patent application No. 2023-137890, filed on Aug. 28, 2023, and PCT application No. PCT/JP 2024/029269 filed on Aug. 19, 2024, the disclosure of which is incorporated herein in its entirety by reference.

### BACKGROUND

The present disclosure relates to an antenna device.

Conventionally, an antenna device including a dielectric substrate provided with a patch conductor, an electromagnetic coupling conductor electromagnetically coupled to the patch conductor, and a transmission conductor connected to the electromagnetic coupling conductor and functioning as a signal line is known (see, for example, International Patent Publication No. WO2004/095639).

### SUMMARY

A conductive layer may be provided on a dielectric plate provided with a radiation conductor such as a patch conductor. Since the conductive layer has low radio wave transparency, the conductive layer is preferably provided so as to surround the radiation conductor in plan view of the dielectric plate. However, when the conductive layer is provided so as to surround the radiation conductor in plan view of the dielectric plate, the directivity (in particular, directivity in a direction at a relatively low elevation angle with respect to a surface (attachment surface) on which the radiation conductor is provided on the dielectric plate) of the antenna device may be reduced by the conductive layer.

The present disclosure provides an antenna device capable of suppressing a decrease in directivity when a conductive layer is provided on a dielectric plate provided with a radiation conductor.

A first aspect is an antenna device, comprising:
a dielectric plate having a first surface provided with a radiation conductor and a second surface opposite to the first surface;
a conductive layer provided on the dielectric plate; and
a feeding structure for feeding the radiation conductor, wherein
when a wavelength of a radio wave transmitted or received by the radiation conductor in air is λ, and a wavelength shortening rate by the dielectric plate is k,
an outer edge of the radiation conductor has a polygonal shape in which a length of at least one side is 0.8×k×(λ/2) or more and 1.3×k×(λ/2) or less, a circular shape in which a diameter is 0.8×k×(λ/2) or more and 1.3×k×(λ/2) or less, or an elliptical shape in which a length of a major axis or a minor axis is 0.8×k×(λ/2) or more and 1.3×k×(λ/2) or less,
the conductive layer has an inner edge surrounding the radiation conductor such that a gap exists between inner edge and the outer edge of the radiation conductor in plan view of the dielectric plate,
the inner edge of the conductive layer has a polygonal shape in which a length of at least one side is 0.25×λ or more and 1.75×λ or less, a circular shape in which a diameter is 0.25×λ or more and 1.75×λ or less, or an elliptical shape in which a length of a major axis or a minor axis is 0.25×λ or more and 1.75×λ or less, and
a sheet resistance of the radiation conductor is equal to or less than a sheet resistance of the conductive layer.

A second aspect is the antenna device according to the first aspect, wherein the sheet resistance of the radiation conductor may be 0.5 [mΩ/sq] or more and 50 [Ω/sq] or less, 1 [mΩ/sq] or more and 25 [Ω/sq] or less, or 3 [mΩ/sq] or more and 5 [Ω/sq] or less.

A third aspect is the antenna device according to the first or second aspect, wherein the sheet resistance of the conductive layer may be 1 [mΩ/sq] or more and 200 [Ω/sq] or less, 3 [mΩ/sq] or more and 50 [Ω/sq] or less, or 300 [mΩ/sq] or more and 25 [Ω/sq] or less.

A fourth aspect is the antenna device according to any of the first to third aspects, wherein
the antenna device may further comprise a light shielding layer formed on the first surface or the second surface, and
the light shielding layer may have a portion overlapping the outer edge of the radiation conductor or the inner edge of the dielectric plate in plan view.

A fifth aspect is the antenna device according to any of the first to fourth aspects, wherein
the conductive layer may include a first conductive layer provided on the first surface, and
the first conductive layer may have a first inner edge which is the inner edge.

A sixth aspect is the antenna device according to any of the first to fifth aspects, wherein
the conductive layer may include a second conductive layer provided on an inner layer of the dielectric plate, and
the second conductive layer may have a second inner edge which is the inner edge.

A seventh aspect is the antenna device according to any of the first to sixth aspects, wherein
the conductive layer may include a first conductive layer provided on the first surface and a second conductive layer provided on an inner layer of the dielectric plate,
the first conductive layer may have a first inner edge which is the inner edge, and
the second conductive layer may have a second inner edge surrounding the first inner edge such that a gap exists between the second inner edge and the first inner edge in plan view of the dielectric plate.

An eighth aspect is the antenna device according to the seventh aspect, wherein the sheet resistance of the radiation conductor may be lower than a sheet resistance of the first conductive layer and the second conductive layer.

A ninth aspect is the antenna device according to any of the first to eighth aspects, wherein the feeding structure may feed to the radiation conductor in a non-contact manner.

A tenth aspect is the antenna device according to any of the first to ninth aspects, wherein the outer edge of the radiation conductor may have a square shape with a set of diagonal notches.

An eleventh aspect is the antenna device according to any of the first to tenth aspects, wherein the radiation conductor may have a cavity formed in a central portion.

According to the present disclosure, it is possible to provide an antenna device capable of suppressing a decrease in directivity when a conductive layer is provided on a dielectric plate provided with a radiation conductor.

The above and other objects, features and advantages of the present disclosure will become more fully understood from the detailed description given hereinbelow and the accompanying drawings.

### BRIEF DESCRIPTION OF DRAWINGS

FIG. 1 is a partial plan view illustrating a configuration example of an antenna device of a first embodiment;

FIG. 2 is a partial cross-sectional view illustrating a configuration example of the antenna device of the first embodiment;

FIG. 3 is a partial cross-sectional view illustrating a configuration example of an antenna device of a second embodiment;

FIG. 4 is a partial cross-sectional view illustrating a configuration example of an antenna device of a third embodiment;

FIG. 5 is a partial cross-sectional view illustrating a configuration example of an antenna device of a fourth embodiment;

FIG. 6 is a partial plan view illustrating an example of a shape of a radiation conductor;

FIG. 7 is a partial plan view illustrating an example of the shape of the radiation conductor;

FIG. 8 is a diagram illustrating an example of a simulation result of directivity of the antenna device;

FIG. 9 is a diagram illustrating an example of a simulation result of directivity of the antenna device;

FIG. 10 is a diagram illustrating an example of a simulation result of directivity of the antenna device;

FIG. 11 is a diagram illustrating an example of a simulation result of directivity of the antenna device; and

FIG. 12 is a diagram illustrating an example of a simulation result of directivity of the antenna device.

### DESCRIPTION OF EMBODIMENTS

Hereinafter, the present embodiment will be described with reference to the drawings. For easy understanding, the scale of each part in the drawings may be different from the actual scale. In directions such as parallel, right angle, orthogonal, horizontal, vertical, up, down, left, and right, and terms such as the same and equal, deviations are allowed to an extent that do not impair functions and effects of the embodiments. The shape of a corner portion is not limited to a right angle, and may be rounded in an arch shape. Overlapping may include partially overlapping. An X-axis direction, a Y-axis direction, and a Z-axis direction represent a direction parallel to an X axis, a direction parallel to a Y axis, and a direction parallel to a Z axis, respectively. The X-axis direction, the Y-axis direction, and the Z-axis direction are orthogonal to each other. An XY plane, a YZ plane, and a ZX plane represent a virtual plane parallel to the X-axis direction and the Y-axis direction, a virtual plane parallel to the Y-axis direction and the Z-axis direction, and a virtual plane parallel to the Z-axis direction and the X-axis direction, respectively.

The antenna device of the present embodiment can be applied to, for example, a global navigation satellite system (GNSS), a vehicle-to-everything (V2X) communication system, a fifth generation mobile communication system (so-called 5G), an in-vehicle radar system, and the like. However, the applicable system is not limited thereto.

The global navigation satellite system (GNSS) is a generic term for satellite positioning systems such as GPS in the United States, a quasi-zenith satellite (QZSS) in Japan, GLONASS in Russia, Galileo in Europe, BeiDou in China, and NAVIC in India. The antenna device of the present embodiment is not limited to GNSS, and is suitable for satellite digital audio radio service (SDARS) or low earth orbiting satellite communication.

One example of the V2X communication system is an ETC system. The antenna device of the present embodiment is suitable for use in a frequency band of 6 GHz or less (sub 6) among frequency bands used in 5G, and may be used, for example, for transmission and reception of radio waves in a 5.8 GHz band or a 5.9 GHz band (one or both of transmission and reception). However, the antenna device of the present embodiment can be used not only for the frequency band (3.3 GHz or more) used in 5G but also for 4G LTE, a millimeter wave band (30 GHz to 300 GHz), and microwaves.

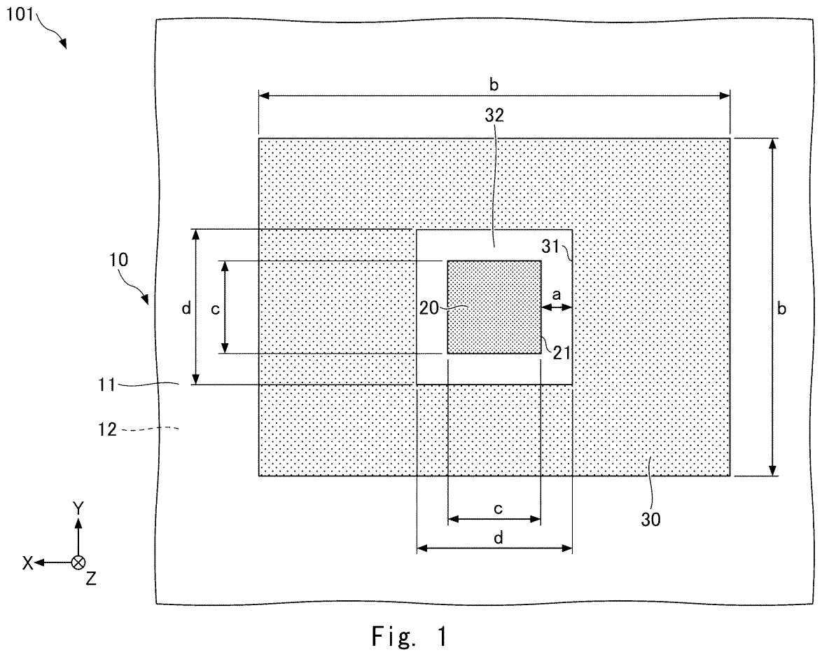

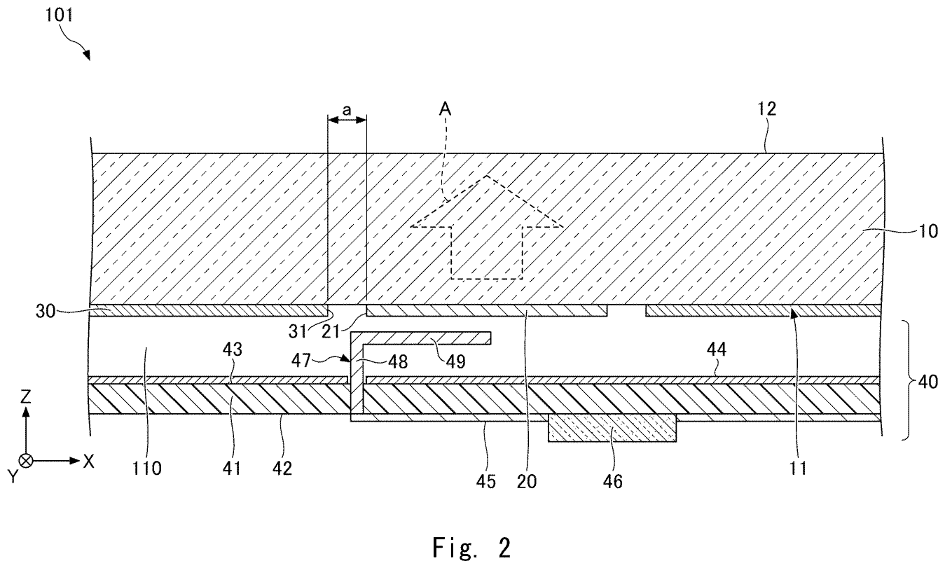

FIG. 1 is a partial plan view illustrating a configuration example of an antenna device of a first embodiment. FIG. 1 is a plan view of a dielectric plate 10. FIG. 2 is a partial cross-sectional view illustrating a configuration example of the antenna device of the first embodiment. An antenna device 101 illustrated in FIGS. 1 and 2 includes a dielectric plate 10 on which a conductive layer 30 is provided, a radiation conductor 20 that transmits or receives a radio wave A through the dielectric plate 10, and a feeding structure 40 that feeds to the radiation conductor 20. In FIG. 1, illustration of the feeding structure 40 is omitted in order to ensure visibility.

The dielectric plate 10 is, for example, a window glass for vehicle. Examples of the window glass for vehicle include a roof glass attached to a ceiling portion of a vehicle, a windshield attached to a front portion of the vehicle, a rear glass attached to a rear portion of the vehicle, and a side glass attached to a side portion of the vehicle. The window glass for a vehicle is not limited thereto, and may be, for example, a window glass in which a roof glass is integrated with one or both of a windshield and a rear glass.

The dielectric plate 10 may be a plate other than a glass plate (for example, a resin plate or the like).

The dielectric plate 10 is a plate-shaped dielectric having a main surface 11 facing the negative Z-axis direction and a main surface 12 facing the direction opposite to the main surface 11 (positive Z-axis direction). Although the main surface 11 and the main surface 12 are illustrated to be parallel to the XY plane, the main surface 11 or the main surface 12 may be curved with respect to the XY plane. When the main surface 11 or the main surface 12 is curved with respect to the XY plane, that is, when the dielectric plate 10 has a curved shape, the dielectric plate 10 may have a single curved shape curved only in one of the left-right direction and the up-down direction, or may have a double curved shape curved in the left-right direction and the up-down direction. When the dielectric plate 10 has a curved shape, the radius of curvature may be 2000 to 11000 mm. When the dielectric plate 10 is a glass plate, gravity molding, press molding, roller molding, and the like are used for bending the dielectric plate 10. The main surface 11 is an example of a first surface on which the radiation conductor is provided. The main surface 12 is an example of a second surface opposite to the first surface.

When the dielectric plate 10 is a window glass for vehicle, for example, the main surface 11 is a surface of the window glass on the vehicle interior side, and the main surface 12 is a surface of the window glass on the vehicle exterior side.

The dielectric plate 10 is, for example, a single-plate window glass for vehicle. The single-plate window glass refers to a window glass including only one glass plate.

The thickness of the glass plate (in the example of FIG. 2, the dielectric plate 10) in the single plate in the Z-axis direction is not particularly limited, but generally can be appropriately selected in the range of 0.5 mm to 10 mm. The thickness of the dielectric plate 10 is preferably 0.5 mm or more, more preferably 0.7 mm or more, still more preferably 1.1 mm or more, and particularly preferably 1.6 mm or more. In addition, the thickness of the dielectric plate 10 is preferably 7 mm or less, more preferably 5 mm or less, and still more preferably 4 mm or less so that the mass does not become too large.

When the dielectric plate 10 is a laminated glass as described later, the thickness of the dielectric plate 10 in the Z-axis direction is not particularly limited, but can be appropriately selected in the range of 0.1 mm to 10 mm. The thickness of the dielectric plate 10 is preferably 0.3 mm or more, more preferably 0.5 mm or more, still more preferably 0.7 mm or more, particularly preferably 1.1 mm or more, and most preferably 1.6 mm or more. The thickness of the dielectric plate 10 is preferably 3.0 mm or less, more preferably 2.6 mm or less, and still more preferably 2.1 mm or less so that the mass of laminated glass does not become too large. Note that the thicknesses of the plurality of glass plates included in the dielectric plate 10 may be the same or different from each other.

When the dielectric plate 10 is a glass plate, the relative permittivity of the dielectric plate 10 is 3.7 or more and 10 or less, and the wavelength shortening rate k by the dielectric plate 10 is 0.316 or more and 0.52 or less.

The conductive layer 30 is provided on the dielectric plate 10. In the example illustrated in FIG. 2, the conductive layer 30 is provided on the main surface 11 of the dielectric plate 10. The conductive layer 30 may be directly provided on the main surface 11 so as to be in contact with the main surface 11, or may be indirectly provided on the main surface 11 so that a predetermined indirect member is interposed between the conductive layer and the main surface 11.

The conductive layer 30 is a planar conductor disposed on the main surface 11 side of the dielectric plate 10. The conductive layer 30 may be a conductor in contact with the main surface 11, or may be a conductor disposed on the main surface 11 side via a transparent or translucent dielectric (not illustrated). The conductive layer 30 may be transparent or translucent. Specific examples of the conductive layer 30 include a metal film such as an Ag (silver) film, a metal oxide film such as an indium tin oxide (ITO) film, a resin film containing conductive fine particles, and a laminate in which a plurality of types of films are laminated. The conductive layer 30 may be formed by coating a resin film such as polyethylene terephthalate by vapor deposition or the like. The conductive layer 30 may be formed in a mesh shape on a film by conductive ink or etching.

The conductive layer 30 may be a conductive film coated on the main surface 11 of the dielectric plate 10. Specific examples of the conductive film include a low-radiation film such as a low emissivity (low-E) film exhibiting low radiation performance.

The low radiation means to reduce heat transfer due to radiation. A low-radiation film such as a low-E film suppresses heat transfer due to radiation, thereby securing heat insulating properties. The low-radiation film may be a general film, and may be, for example, a laminated film including a transparent dielectric film, an infrared reflecting film, and a transparent dielectric film in this order. The transparent dielectric material film is typically a metal oxide or a metal nitride. As the metal oxide, zinc oxide and tin oxide are representative. The infrared reflecting film is typically a metal film. The metal film is typically silver (Ag). Here, one or more infrared reflecting films may be formed between the transparent dielectric material films.

In addition, the conductive layer 30 is not limited to a low-radiation film such as a low-E film, and may have other functions as long as it is conductive. For example, the conductive layer 30 may have functions (for example, anti-icing or anti-fogging) of the dielectric plate 10 such as a window glass by heat generation due to voltage application.

The conductive layer 30 may be a conductive film included in a light control film capable of actively changing the visible light transmittance of the dielectric plate 10 by applying an AC voltage. The light control film has, for example, a molecular layer having optical anisotropy between a pair of facing resin substrates. A conductive film and an electrode electrically connected to the conductive film are provided on the main surface of each resin substrate. Then, the light control film is driven by applying a voltage between the pair of conductive layers via the electrode.

The resin substrate is made of, for example, a transparent resin. The resin substrate may have, for example, polyethylene terephthalate (PET), polycarbonate (PC), or cycloolefin polymer (COP). In addition, for example, the above-described resins may be used in combination as the pair of facing resin substrates. The thickness of the resin substrate is, for example, in the range of 5 μm to 500 μm, preferably in the range of 10 μm to 200 Σm, more preferably in the range of 20 μm to 180 μm, and still more preferably in the range of 50 μm to 150 μm.

The conductive film may include, for example, a transparent conductive oxide, a transparent conductive polymer, a laminated film of a metal layer and a dielectric layer, a silver nanowire, a metal mesh of silver or copper, and the like. The thickness of the conductive film may be, for example, in a range of 5 nm to 2 μm.

Examples of the molecule having optical anisotropy include liquid crystals. That is, for example, a liquid crystal layer may be used as the molecular layer having optical anisotropy. Examples of the liquid crystal layer include polymer dispersed liquid crystal (PDLC), polymer network liquid crystal (PNLC), and guest-host liquid crystal. Alternatively, iodine or the like may be used as the molecule having optical anisotropy. The light control film may have a suspended particle device (SPD) including such a molecular layer.

The radiation conductor 20 is provided on the main surface 11 of the dielectric plate 10. The radiation conductor 20 may be directly provided on the main surface 11 so as to be in contact with the main surface 11, or may be indirectly provided on the main surface 11 so that a predetermined indirect member is interposed between the radiation conductor and the main surface 11.

The radiation conductor 20 is a planar conductor disposed on the main surface 11 side of the dielectric plate 10. The radiation conductor 20 may be a conductor in contact with the main surface 11, or may be a conductor disposed on the main surface 11 side via a transparent or translucent dielectric (not illustrated). The radiation conductor 20 may be transparent or translucent. Specific examples of the radiation conductor 20 include a conductor formed by coating and firing a silver paste containing silver powder and glass frit on the dielectric plate 10, a metal film such as an Ag (silver) film, a metal oxide film such as an ITO (indium tin oxide) film, a resin film containing conductive fine particles, and a laminate obtained by laminating a plurality of types of films containing conductive films. The radiation conductor 20 may be formed by coating a resin film such as polyethylene terephthalate by vapor deposition or the like. The radiation conductor 20 may be formed in a mesh shape on a film by conductive ink or etching. The radiation conductor 20 may be a conductive film coated on the main surface 11 of the dielectric plate 10.

The radiation conductor 20 is, for example, a flat pattern formed of a conductor on the main surface 11. The shape of the radiation conductor 20 in plan view is not limited to a quadrangle, and may be another shape (for example, a polygon other than a quadrangle, a circle, an ellipse, or the like). The squares, polygons, circles, and ellipses may include substantially squares, substantially polygons, substantially circles, and substantially ellipses, respectively.

The radiation conductor 20 is a radiation element that transmits or receives a radio wave A having a frequency included in a predetermined frequency band W through the dielectric plate 10. The radiation conductor 20 is also referred to as a patch conductor.

The frequency band W is a relatively high band of a UHF (Ultra High Frequency) band of 300 MHz to 3 GHz, a SHF (Super High Frequency) band of 3 GHz to 30 GHz, or an EHF (Extremely High Frequency) band of 30 GHz to 300 GHz. As a specific example of such a high frequency band, there is a band (frequency band of 6 GHz or less (sub 6) and frequency band of 24 GHz or more (28 GHz band, 39 GHz band, and the like)) used in the fifth generation communication (5G) standard.

The feeding structure 40 feeds to the radiation conductor 20. In the example illustrated in FIG. 2, the feeding structure 40 feeds to the radiation conductor 20 in a non-contact manner by electromagnetic coupling or the like.

By the contactless supply, mountability and durability against vibration and the like are improved. The feeding structure 40 may perform contact feeding to the radiation conductor 20.

The feeding structure 40 is disposed on the main surface 11 side of the dielectric plate 10, and has a configuration in which at least a part thereof overlaps the radiation conductor 20 in plan view. The feeding structure 40 includes, for example, a substrate 41 and a feeding conductor 47.

The substrate 41 is a plate-shaped dielectric body having a substrate surface 42 facing the negative Z-axis direction and a substrate surface 43 facing a direction opposite to the substrate surface 42 (positive Z-axis direction). The substrate surface 43 faces the main surface 11. Although the substrate surface 42 and the substrate surface 43 are illustrated to be parallel to the XY plane, the substrate surface 42 or the substrate surface 43 may be curved with respect to the XY plane.

A signal line 45 is formed on the substrate surface 42, and a ground conductor 44 is formed on the substrate surface 43. The signal line 45 faces the ground conductor 44 with the dielectric substrate 41 interposed therebetween, and thus forms a transmission line. On the substrate surface 42, a semiconductor component 46 such as an amplifier that amplifies a signal transmitted through the signal line 45 is mounted.

The feeding conductor 47 is a feed element that feeds to the radiation conductor 20 in a non-contact manner. The feeding conductor 47 is, for example, electromagnetically coupled to the radiation conductor 20, and feeds to the radiation conductor 20 in a contactless manner by electromagnetic coupling.

The feeding conductor 47 is electrically connected to one end of the signal line 45. The feeding conductor 47 is not direct-current connected to the ground conductor 44.

The feeding conductor 47 has, for example, a portion facing the radiation conductor 20 in the Z-axis direction. In the example illustrated in FIG. 2, the feeding conductor 47 includes an L-shaped conductor portion having a vertical portion 48 and a parallel portion 49. The vertical portion 48 is fixed to the substrate 41 in a state of penetrating the substrate 41. The vertical portion 48 extends in the positive Z-axis direction from the substrate surface 43. One end of the parallel portion 49 is connected to an end portion of the vertical portion 48 in the positive Z-axis direction. The parallel portion 49 extends parallel to the ground conductor 44 and the radiation conductor 20. The parallel portion 49 is separated from the ground conductor 44 in the positive Z-axis direction and is separated from the radiation conductor 20 in the negative Z-axis direction.

A dielectric layer 110 is present between the feeding structure 40 and the main surface 11. The dielectric layer 110 may be air or a solid dielectric. The feeding structure 40 is fixed with respect to the main surface 11 such that the dielectric layer 110 exists between the feeding structure and the main surface 11.

The conductive layer 30 has an inner edge 31 surrounding the radiation conductor 20 such that a gap exists between the inner edge 31 and an outer edge 21 of the radiation conductor 20 in plan view of the dielectric plate 10. The gap length a indicates the length of the gap in plan view of the dielectric plate 10.

The inner edge 31 forms an opening 32 (see FIG. 1) surrounding the radiation conductor 20 in plan view. The opening 32 functions as a window through which the radio wave A transmitted or received by the radiation conductor 20 passes.

The inner edge 31 is formed so as to surround the radiation conductor 20 in plan view. In the example shown in FIG. 1, the inner edge 31 forms the opening 32 that is completely closed by the conductive layer 30 in plan view.

However, due to the cutout in a part of the inner edge 31, the opening 32 may not be completely closed by the conductive layer 30 in plan view.

The conductive layer 30 in the first embodiment is an example of a first conductive layer provided on a first surface on which the radiation conductor is provided. The inner edge 31 is an example of a first inner edge which is an inner edge of the first conductive layer.

Here, a wavelength of the radio wave A transmitted or received by the radiation conductor 20 in the air is λ, and a wavelength shortening rate by the dielectric plate 10 is k. At this time, the outer edge 21 of the radiation conductor 20 has a polygonal shape in which the length of at least one side is 0.8×k×(λ/2) or more and 1.3×k×(λ/2) or less, a circular shape in which the diameter is 0.8×k×(λ/2) or more and 1.3×k×(λ/2) or less, or an elliptical shape in which the length of the major axis or the minor axis is 0.8×k×(λ/2) or more and 1.3×k×(λ/2) or less. Hereinafter, this dimensional shape condition is defined as “condition C”. In addition, regarding the shape of the outer edge 21, the length of one side, the diameter, or the length of the major axis or the minor axis is defined as “length c”. FIG. 1 illustrates a case where the outer edge 21 satisfying the condition C is a square.

When the outer edge 21 satisfies the condition C, the radiation conductor 20 having the length c with k×(λ/2) as the median value is formed, so that the radiation conductor 20 functions as a radiation element of a patch antenna. Therefore, the antenna gain of the antenna device 101 that transmits or receives the radio wave A having the wavelength λ is improved as compared with the case where the condition C is not satisfied.

The conditional expression “0.8×k×(λ/2) or more and 1.3×k×(λ/2) or less” in the condition C is preferably “0.8×k×(λ/2) or more and 1.2×k×(λ/2) or less”, more preferably “0.9×k×(λ/2) or more and 1.1×k×(λ/2) or less”, and still more preferably “0.95×k×(λ/2) or more and 1.05×k×(λ/2) or less” from the viewpoint of improving the antenna gain.

On the other hand, the inner edge 31 of the conductive layer 30 has a polygonal shape in which a length of at least one side is 0.25×λ or more and 1.75×λ or less, a circular shape in which a diameter is 0.25×λ or more and 1.75×λ or less, or an elliptical shape in which a length of a major axis or a minor axis is 0.25×λ or more and 1.75×λ or less. Hereinafter, this dimensional shape condition is defined as “condition D”. In addition, regarding the shape of the inner edge 31, the length of one side, the diameter, or the length of the major axis or the minor axis is defined as “length d”. FIG. 1 illustrates a case where the inner edge 31 satisfying the condition D is a square.

When the inner edge 31 satisfies the condition D, the opening 32 functions as a radio wave transmission window having a length d with (1×λ) as a median value. When the inner edge 31 satisfies the condition D, the directivity (in particular, directivity in a direction at a relatively low elevation angle with respect to the main surface 11 (attachment surface) on which the radiation conductor 20 is provided) of the antenna device 101 is improved as compared with the case where the condition D is not satisfied, as shown in a simulation example to be described later. This is because, when the inner edge 31 satisfies the condition D, the influence of the portion of the inner edge 31 of the conductive layer 30 on the radio wave A is reduced as compared with the case where the condition D is not satisfied.

The conditional expression “0.25×λ or more and 1.75×λ or less” in the condition D is preferably “0.5×λ or more and 1.5×λ or less”, and more preferably “0.8×λ or more and 1.2λ or less” from the viewpoint of improving the antenna gain.

The gap length a between the outer edge 21 of the radiation conductor 20 and the inner edge 31 of the conductive layer 30 may be {0.25×λ−0.8×k×(λ/2)}2 or more and {1.75×λ−1.2×k×(λ/2)}/2 or less. Thus, the directivity (in particular, directivity in a direction at a relatively low elevation angle with respect to the main surface 11 (attachment surface) on which the radiation conductor 20 is provided) of the antenna device 101 is improved.

The sheet resistance (hereinafter, also referred to as “sheet resistance R20”) of the radiation conductor 20 is preferably low in order to improve radiation efficiency as an antenna, and is preferably lower than the sheet resistance (hereinafter, also referred to as “sheet resistance R30”) of the conductive layer 30. As a result, radiation characteristics by the radiation conductor 20 are improved, and directivity (in particular, directivity in a direction at a relatively low elevation angle with respect to the main surface 11) of the antenna device 101 is improved.

The sheet resistance R20 is preferably as low as possible from the viewpoint of the radiation efficiency of the antenna, but is, for example, 0.5 [mΩ/sq] or more and 50 [Ω/sq] or less, preferably 1 [mΩ/sq] or more and 25 [Ω/sq] or less, and more preferably 3 [mΩ/sq] or more and 5 [Ω/sq] or less. The sheet resistance R30 is, for example, 1[mΩ/sq] or more and 200 [Ω/sq] or less, preferably 3 [mΩ/sq] or more and 50 [Ω/sq] or less, and more preferably 300 [mΩ/sq] or more and 25 [Ω/sq] or less.

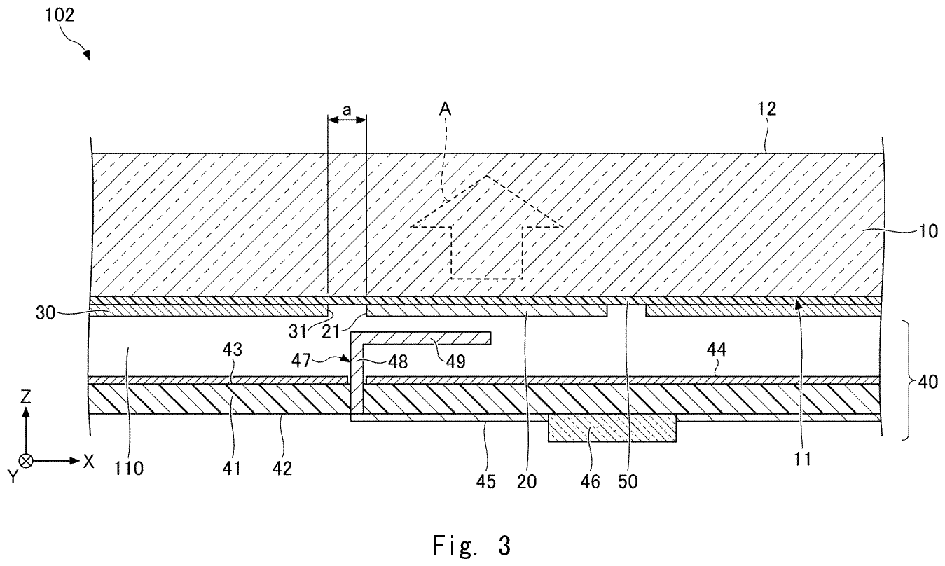

FIG. 3 is a partial cross-sectional view illustrating a configuration example of an antenna device of a second embodiment. In the second embodiment, description of the same configuration, operation, and effect as those of the above embodiment will be omitted by incorporating the above description. An antenna device 102 illustrated in FIG. 3 is different from the antenna device 101 in including a light shielding layer 50.

In FIG. 3, the antenna device 102 includes the light shielding layer 50 formed on the main surface 11. The light shielding layer 50 has a portion overlapping with the outer edge 21 or the inner edge 31 of the dielectric plate 10 in plan view. As a result, since the outer edge 21 or the inner edge 31 overlaps the light shielding layer 50 in plan view, the outer edge 21 or the inner edge 31 becomes less noticeable. In addition, since at least a part of the opening 32 also overlaps the light shielding layer 50 in plan view, the opening 32 becomes less noticeable. Therefore, the appearance of the antenna device is improved, and the appearance of the window glass as a whole is also improved.

The light shielding layer 50 is a layer that shields visible light. When the dielectric plate 10 is a laminated glass, the light shielding layer 50 may be formed on inner main surfaces of a plurality of glass plates constituting the laminated glass.

The light shielding layer 50 is, for example, an opaque colored ceramic layer having a thickness of about 5 μm to 25 μm. The color of the light shielding layer 50 is arbitrary, but is preferably a dark color such as black, brown, gray, and deep blue, or white, and more preferably black. The light shielding layer 50 is formed by applying and firing a ceramic paste containing a dark or white pigment such as black, brown, gray, or deep blue, and glass frit on the dielectric plate 10.

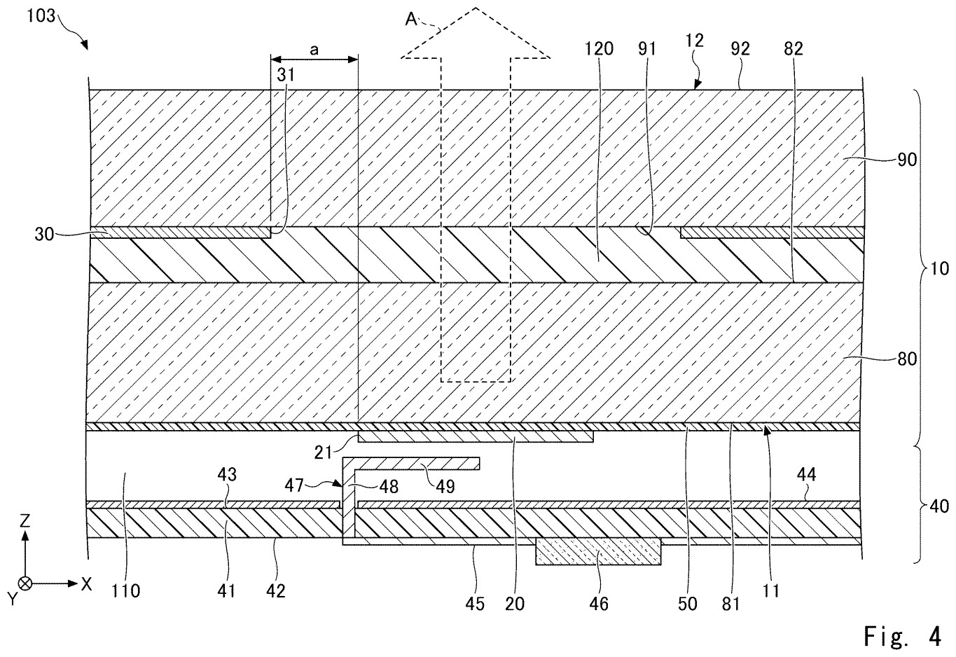

FIG. 4 is a partial cross-sectional view illustrating a configuration example of an antenna device of a third embodiment. In the third embodiment, the description of the same configuration, operation, and effect as those of the above-described embodiment will be omitted or simplified by incorporating the above description. An antenna device 103 illustrated in FIG. 4 is different from the antenna device 102 in that the conductive layer 30 is provided on the inner layer of the dielectric plate 10.

The dielectric plate 10 is, for example, a laminated glass for vehicles.

The dielectric plate 10 includes a glass plate 80, a glass plate 90, and an interlayer film 120. In the example illustrated in FIG. 4, the dielectric plate 10 is a laminated glass in which the glass plate 80 disposed on the vehicle interior side and the glass plate 90 disposed on the vehicle exterior side are bonded to each other with the interlayer film 120 interposed therebetween. The interlayer film 120 is sandwiched between the glass plate 80 and the glass plate 90.

The glass plate 80 and the glass plate 90 are transparent dielectric plates. One or both of the glass plate 80 and the glass plate 90 may be translucent. The glass plate 80 is an example of a first dielectric plate, and the glass plate 90 is an example of a second dielectric plate.

The glass plate 80 has a main surface 81 facing the negative Z-axis direction and a main surface 82 facing a direction opposite to the main surface 81 (positive Z-axis direction). The main surface 81 is an example of a first main surface. The glass plate 90 has a main surface 91 facing the negative Z-axis direction and a main surface 92 facing a direction opposite to the main surface 91 (positive Z-axis direction). The main surface 92 is an example of a second main surface.

The interlayer film 120 is a film having dielectric properties and disposed between the main surface 82 of the glass plate 80 and the main surface 91 of the glass plate 90. The interlayer film 120 is a transparent or translucent dielectric interposed between the glass plate 80 and the glass plate 90. The glass plate 80 and the glass plate 90 are bonded by the interlayer film 120. Examples of the interlayer film 120 include thermoplastic polyvinyl butyral (PVB), an ethylene vinyl acetate copolymer (EVA), and a cycloolefin polymer (COP). The relative permittivity of the interlayer film 120 is preferably 2.4 or more and 3.5 or less.

The conductive layer 30 in the third embodiment is an example of a second conductive layer provided on the inner layer of the dielectric plate. The inner edge 31 is an example of a second inner edge which is an inner edge of the second conductive layer. In the example illustrated in FIG. 4, the conductive layer 30 is provided on the main surface 91. However, the conductive layer 30 may be provided on the main surface 82.

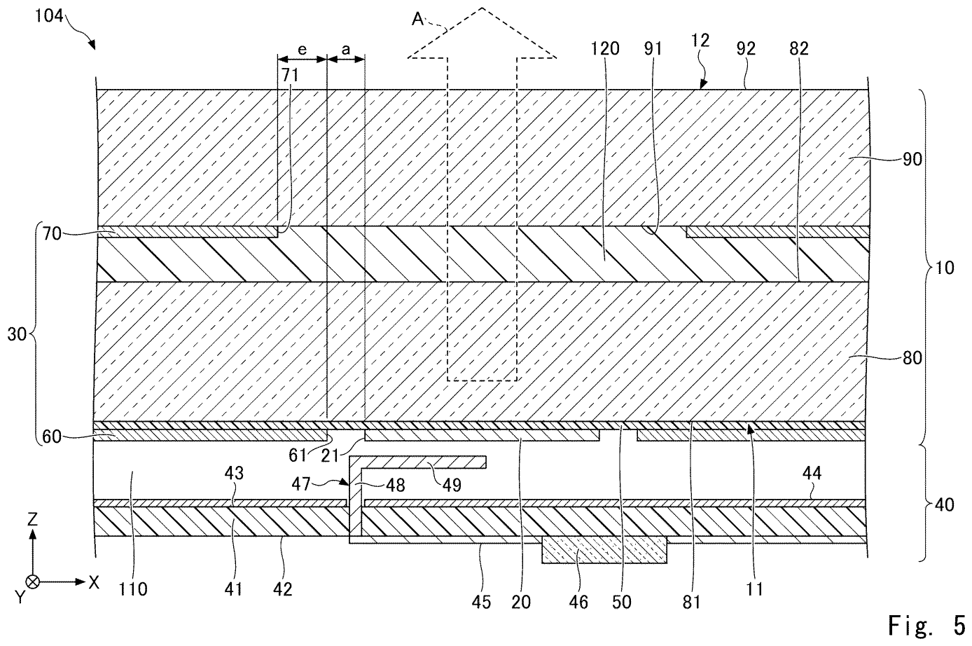

FIG. 5 is a partial cross-sectional view illustrating a configuration example of an antenna device of a fourth embodiment. In the fourth embodiment, the description of the same configuration, operation, and effect as those of the above-described embodiment will be omitted or simplified by incorporating the above description. An antenna device 104 illustrated in FIG. 5 is different from the antenna device 102 or the antenna device 103 described above in that the conductive layer 30 includes a plurality of conductive layers (in this example, two conductive layers 60 and 70).

The conductive layer 60 in the fourth embodiment is an example of a first conductive layer provided on a first surface on which the radiation conductor is provided. An inner edge 61 is an example of a first inner edge which is an inner edge of the first conductive layer. The conductive layer 70 in the fourth embodiment is an example of a second conductive layer provided on the inner layer of the dielectric plate. An inner edge 71 is an example of a second inner edge which is an inner edge of the second conductive layer.

The conductive layer 30 includes a conductive layer 60 provided on the main surface 11 (main surface 81) and a conductive layer 70 provided on the inner layer of the dielectric plate 10. The conductive layer 60 has the inner edge 61 that satisfies the above condition D. The conductive layer 70 has the inner edge 71 surrounding the inner edge 61 such that a gap exists between the inner edge 61 and the inner edge 71 in plan view of the dielectric plate 10. A gap length e indicates the length of the gap in plan view of the dielectric plate 10. The inner edges 61 and 71 form an opening 32 (see FIG. 1) surrounding the radiation conductor 20 in plan view. The opening 32 functions as a window through which the radio wave A transmitted or received by the radiation conductor 20 passes.

The inner edge 71 is located outside the inner edge 61 in the direction along the XY plane in plan view. As a result, the influence of the inner edge 61 of the conductive layer 60 on the radio wave A is mainly exerted, and the influence of the portion of the inner edge 71 of the conductive layer 70 is reduced. Therefore, the directivity (in particular, directivity in a direction at a relatively low elevation angle with respect to the main surface 11 (attachment surface) on which the radiation conductor 20 is provided) of the antenna device 104 is improved as compared with the case where the inner edge 71 is located inside the inner edge 61 in plan view.

The sheet resistance R20 of the radiation conductor 20 is preferably low in order to improve radiation efficiency as an antenna, and is preferably lower than the sheet resistance (hereinafter, also referred to as “sheet resistance R60”) of the conductive layer 60 and the sheet resistance (hereinafter, also referred to as “sheet resistance R70”) of the conductive layer 70. As a result, radiation characteristics by the radiation conductor 20 are improved, and directivity (in particular, directivity in a direction at a relatively low elevation angle with respect to the main surface 11) of the antenna device 104 is improved.

The sheet resistance R60 is, for example, 1 [mΩ/sq] or more and 200 [Ω/sq] or less, preferably 3 [mΩ/sq] or more and 50 [Ω/sq] or less, and more preferably 300 [mΩ/sq] or more and 25 [Ω/sq] or less. The sheet resistance R70 is, for example, 1 [mΩ/sq] or more and 200 [Ω/sq] or less, preferably 3 [mΩ/sq] or more and 50 [Ω/sq] or less, and more preferably 300 [mΩ/sq] or more and 25 [Ω/sq] or less. However, the sheet resistance R70 of the conductive layer 70 may be lower than the sheet resistance R60 of the conductive layer 60.

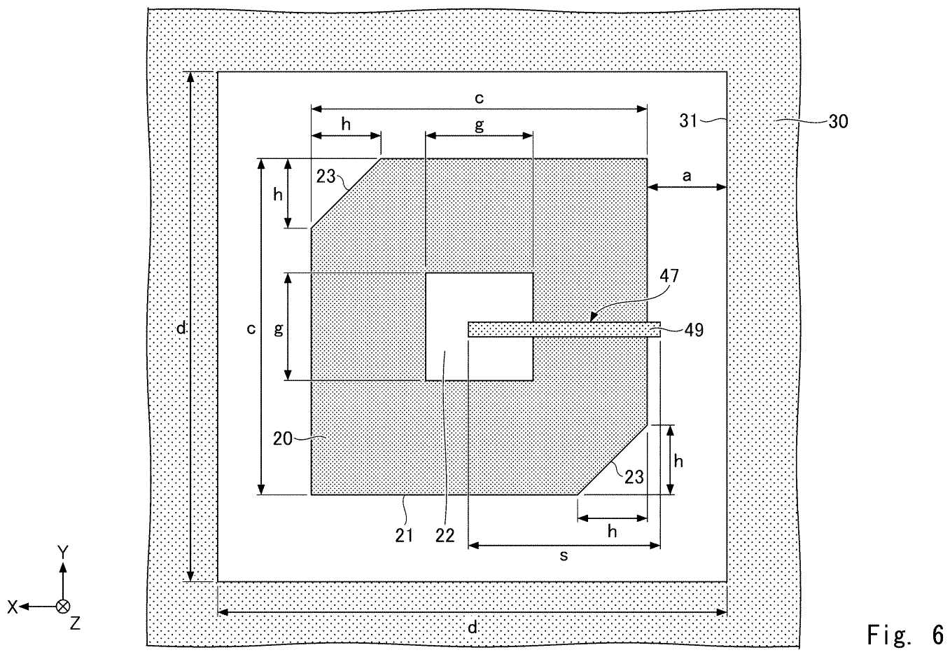

FIG. 6 is a partial plan view illustrating an example of the shape of the radiation conductor. The outer edge 21 of the radiation conductor 20 has a square shape with a pair of diagonal notches. In order to improve the circularly polarized wave characteristics of the antenna device (radiation conductor 20), it is preferable to provide a notch 23 in the radiation conductor 20. However, the present invention is not limited thereto, and the notch 23 may not be provided on the radiation conductor 20. In the example illustrated in FIG. 6, the shape of the notch 23 is a right angled isosceles triangle or a substantially right angled isosceles triangle, but the shape of the notch 23 is not limited thereto.

A cavity (void) 22 is formed in a central portion of the radiation conductor 20. The cavity 22 is a place where no conductor is provided. The presence of the cavity 22 makes it possible to downsize the radiation conductor 20 as compared with a case where the cavity 22 is not present, and to reduce distortion caused by a difference in thermal distribution when the radiation conductor 20 is formed by coating and firing such as screen printing of silver paste. The shape of the cavity 22 is not limited to a square, and may be a polygon other than a square, a circle, an ellipse, or the like.

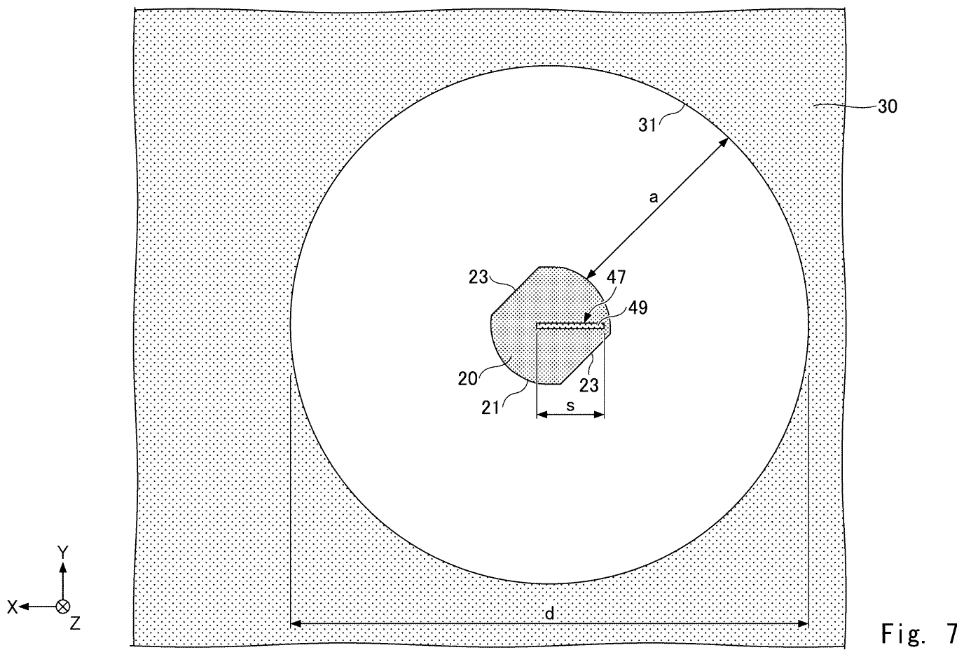

FIG. 7 is a partial plan view illustrating an example of the shape of the radiation conductor. The outer edge 21 of the radiation conductor 20 has a circular shape or an elliptical shape in which a set of diagonals is cut out. In order to improve the circularly polarized wave characteristics of the antenna device (radiation conductor 20), it is preferable to provide a notch 23 in the radiation conductor 20. In the example illustrated in FIG. 7, the inner edge 31 of the conductive layer 30 is circular.

The shape of the outer edge 21 is a polygon, a circle, or an ellipse, and the shape of the inner edge 31 is also a polygon, a circle, or an ellipse. The outer edge 21 and the inner edge 31 may have any combination of shapes. For example, the shape of the outer edge 21 may be a polygon and the shape of the inner edge 31 may be a circle, or the shape of the outer edge 21 may be a circle and the shape of the inner edge 31 may be a polygon.

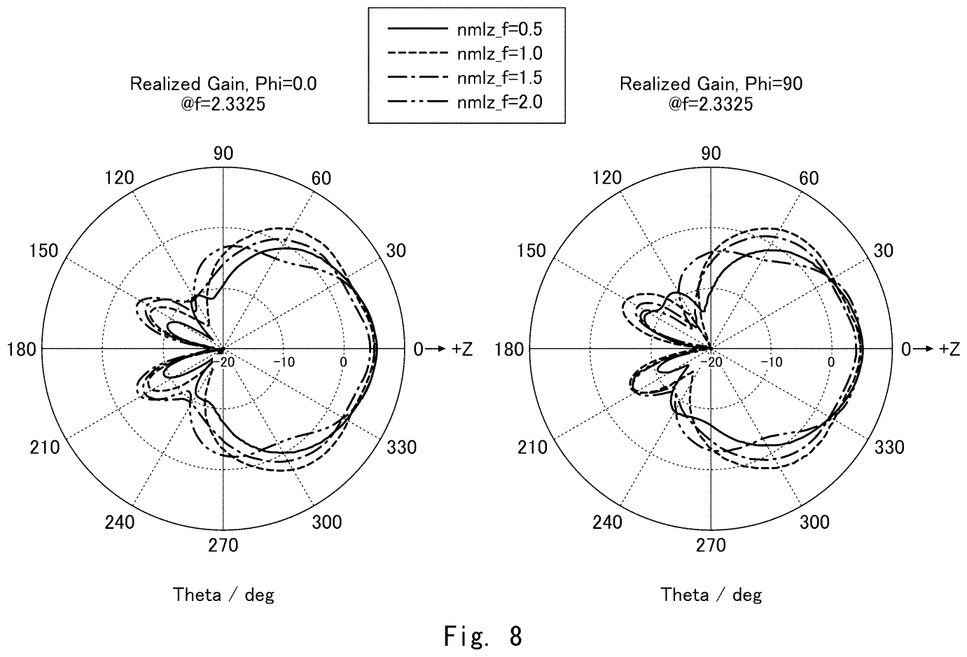

FIG. 8 is a diagram illustrating an example of a simulation result of the directivity of the antenna device when the size of the opening 32 is changed by changing the length d. FIG. 8 illustrates a simulation example of the antenna device 101 (FIG. 2) including the radiation conductor 20 having the shape illustrated in FIG. 6, and illustrates a case where both the radiation conductor 20 and the conductive layer 30 are perfect conductors (sheet resistance is 0).

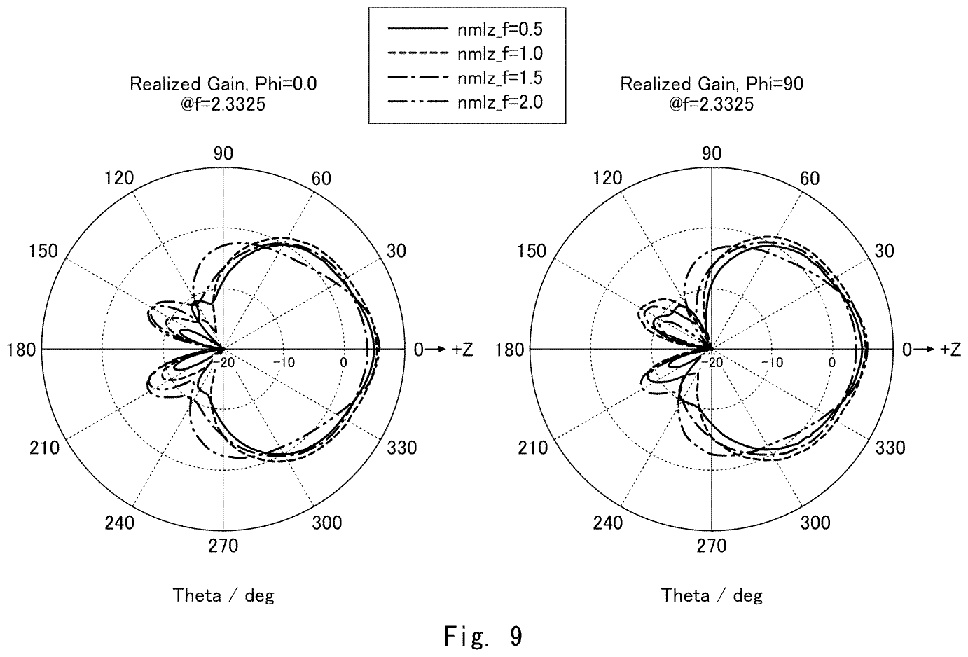

FIG. 9 is a diagram illustrating an example of a simulation result of the directivity of the antenna device when the size of the opening 32 is changed by changing the length d. FIG. 9 illustrates a simulation example of the antenna device 101 (FIG. 2) including the radiation conductor 20 having the shape illustrated in FIG. 6, and illustrates a case where the sheet resistance of the radiation conductor 20 is 1.0[mΩ/sq] corresponding to the sheet resistance of the copper foil, and the sheet resistance of the conductive layer 30 is 15 [Ω/sq]. When the sheet resistance of the radiation conductor 20 was set to 4.0 [mΩ/sq] corresponding to the sheet resistance of the conductor formed by screen printing and firing of the silver paste, the same result as in FIG. 9 was obtained.

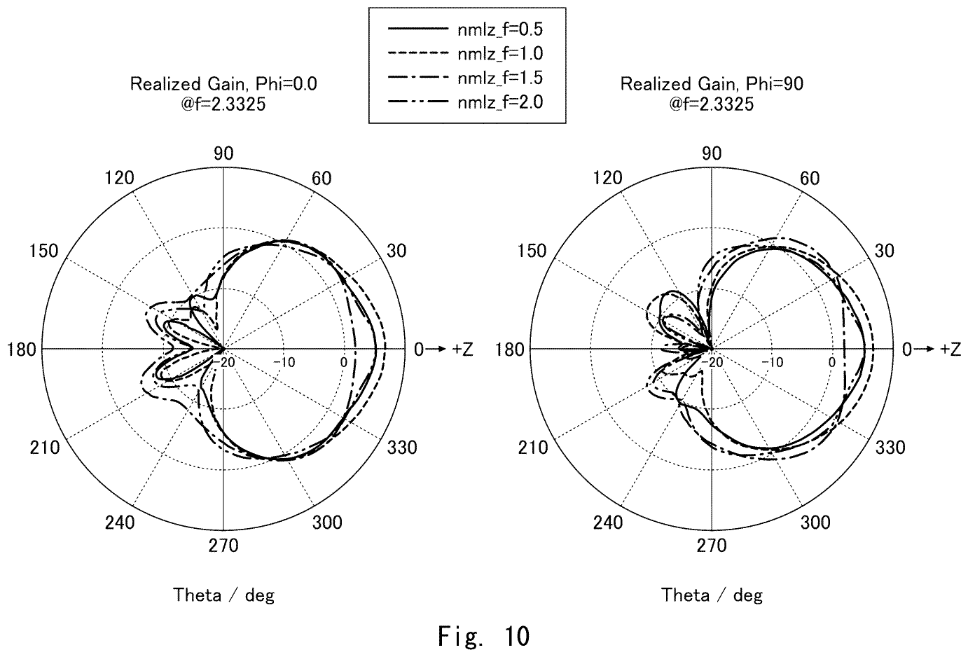

FIG. 10 is a diagram illustrating an example of a simulation result of the directivity of the antenna device when the size of the opening 32 is changed by changing the length d. FIG. 10 illustrates a simulation example of the antenna device 101 (FIG. 2) including the radiation conductor 20 having the shape illustrated in FIG. 7, and illustrates a case where the sheet resistance of the radiation conductor 20 is 4.0 [mΩ/sq] corresponding to the sheet resistance of the conductor formed by screen printing and firing of silver paste, and the conductive layer 30 is a perfect conductor.

In FIGS. 8, 9, and 10, “Phi=0.0” indicates directivity on the ZX plane. “Phi=90” indicates the directivity on the YZ plane. The shape of the inner edge 31 in FIGS. 8 and 9 is a square whose length d is the length of one side. The shape of the inner edge 31 in FIG. 10 is a circle having a diameter equivalent to the length d. Here, the length d is defined as nmlz_f×λg, and is a value normalized by the wavelength λg. λg is a wavelength λ of a radio wave having a frequency f of 2.3325 GHz. “nmlz_f=0.5”, “nmlz_f=1.0”, and “nmlz_f=1.5” satisfy the condition D described above. “nmlz_f=2.0” does not satisfy the condition D.

As illustrated in FIGS. 8, 9, and 10, when the condition D is satisfied, the directivity of the antenna device is improved as compared with the case where the condition D is not satisfied. In particular, the directivity in the direction at a relatively low elevation angle with respect to the main surface 11 (attachment surface) is improved as compared with the case where the condition D is not satisfied. When the normal direction of the main surface 11 is set to 0°, not only the directivity in the normal direction of the main surface 11 but also the directivity in the low elevation angle range of 40° or more and 70° or less and 290° or more and 320° or less are improved.

Note that conditions such as dimensions of each part in FIGS. 8, 9, and 10 are as follows:
Dielectric plate 10: laminated glass (interlayer film 120, glass plate 80, and glass plate 90)
Thickness of glass plate 80: 2 mm
Thickness of glass plate 90: 2 mm
Thickness of interlayer film 120: 0.76 mm
Material of interlayer film 120: PVB
Material of substrate 41: FR-4
Thickness of substrate 41: 0.8 mm
Thickness of dielectric layer 110: 3.6 mm
Adhesive layer between feeding structure 40 and main surface 11: acrylic foam tape
Thickness of adhesive layer between feeding structure 40 and main surface 11: 0.8 mm
Ground conductor 44: square 55 mm long and 55 mm wide
Length c of radiation conductor 20: 26.15 mm
Length h of notch 23: 5.5 mm
Length g of cavity 22: 8 mm
Length s of feeding conductor 47: 14.4 mm

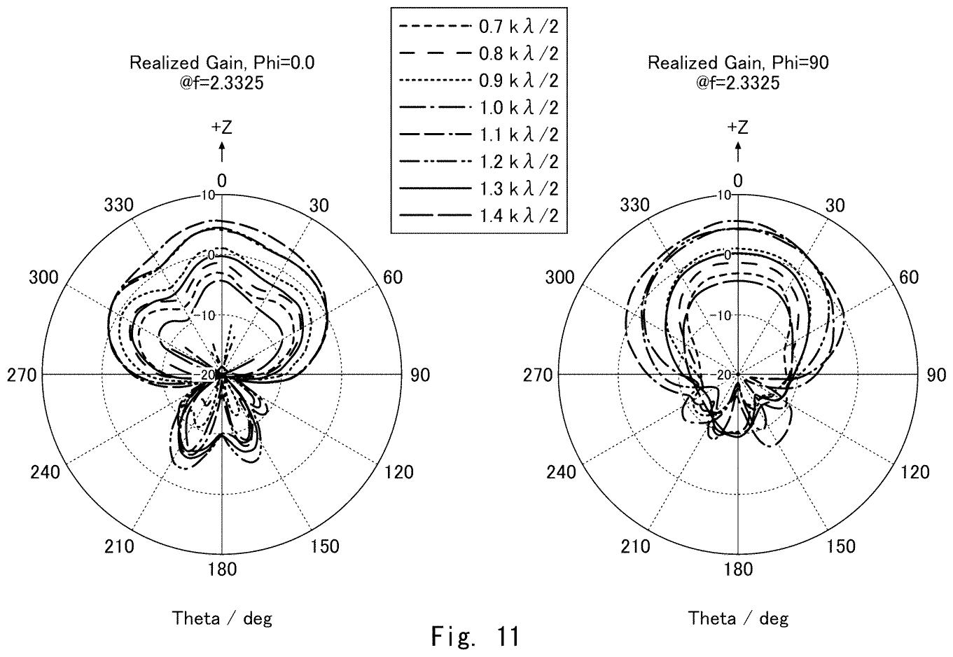

FIG. 11 is a diagram illustrating an example of a simulation result of the directivity of the antenna device when the size of the opening 32 is changed by changing the length c in a range from 0.7×k×(λ/2) to 1.4×k×(λ/2) or less. FIG. 11 illustrates a simulation example of the antenna device 101 (FIG. 2) including the radiation conductor 20 having the shape illustrated in FIG. 6, and illustrates a case where the sheet resistance of the radiation conductor 20 is 1.0 [mΩ/sq] corresponding to the sheet resistance of the copper foil, and the sheet resistance of the conductive layer 30 is 15 [Ω/sq].

In FIG. 11, “Phi=0.0” indicates directivity on the ZX plane. “Phi=90” indicates the directivity on the YZ plane. The shape of the inner edge 31 in FIG. 11 is a square in which the length of one side is a length d. Here, the length d is 130 mm, the frequency f of the radio wave is 2.3325 GHZ (wavelength λ=128.6 mm), the dielectric plate 10 is glass having a relative dielectric constant of 7, and the wavelength shortening rate k is 0.378. The condition C is not satisfied when the length c is “0.7×k×(λ/2)” or “1.4×k×(λ/2)”, but the condition C is satisfied when the length c is other than these.

As illustrated in FIG. 11, in the case that the condition C is satisfied, the directivity of the antenna device is improved as compared with the case that the condition C is not satisfied. In particular, the directivity in the direction at a relatively low elevation angle with respect to the main surface 11 (attachment surface) is improved as compared with the case where the condition C is not satisfied. When the normal direction of the main surface 11 is set to 0°, not only the directivity in the normal direction of the main surface 11 but also the directivity in the low elevation angle range of 40° or more and 70° or less and 290° or more and 320° or less are improved.

Note that conditions such as dimensions of each part in FIG. 11 are the same as the above conditions in the cases of FIGS. 8 and 9.

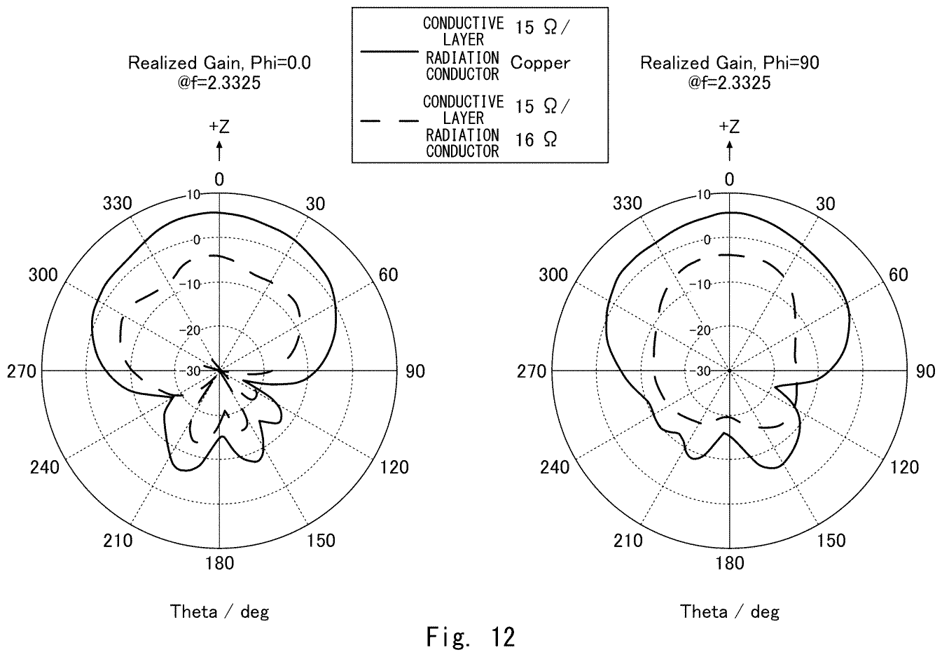

FIG. 12 is a diagram illustrating an example of a simulation result of the antenna device when the magnitude relationship of the sheet resistance between the radiation conductor 20 and the conductive layer 30 is made different. FIG. 12 illustrates a simulation example of the antenna device 101 (FIG. 2) including the radiation conductor 20 having the shape illustrated in FIG. 6. “Conductive layer 15 Ω/radiation conductor Copper” indicates an example in a case where the sheet resistance of the radiation conductor 20 is 1.0 [mΩ/sq] corresponding to the sheet resistance of the copper foil, and the sheet resistance of the conductive layer 30 is 15 [Ω/sq] (a case where the sheet resistance of the radiation conductor 20 is lower than the sheet resistance of the conductive layer 30). “Conductive layer 15 Ω/radiation conductor 16Ω” indicates a comparative example in a case where the sheet resistance of the radiation conductor 20 is 16 [Ω/sq] and the sheet resistance of the conductive layer 30 is 15 [Ω/sq] (a case where the sheet resistance of the radiation conductor 20 is higher than the sheet resistance of the conductive layer 30).

In FIG. 12, “Phi=0.0” indicates directivity on the ZX plane. “Phi=90” indicates the directivity on the YZ plane. The shape of the inner edge 31 in FIG. 12 is a square in which the length of one side is a length d. Here, the length d is 130 mm, the frequency f of the radio wave is 2.3325 GHz (wavelength λ=128.6 mm), the dielectric plate 10 is glass having a relative dielectric constant of 7, and the wavelength shortening rate k is 0.378.

As illustrated in FIG. 12, in the example in which the sheet resistance of the radiation conductor 20 is lower than the sheet resistance of the conductive layer 30, the antenna gain of the antenna device is entirely improved as compared with the case of the comparative example in which the sheet resistance of the radiation conductor 20 is higher than the sheet resistance of the conductive layer 30.

Note that conditions such as dimensions of each part in FIG. 12 are the same as the above conditions in the cases of FIGS. 8 and 9.

As described above, the embodiment has been described, but the above embodiment is presented as an example, and the present invention is not limited by the above embodiment. The above-described embodiment can be implemented in various other forms, and various combinations, omissions, substitutions, changes, and the like can be made without departing from the gist of the invention. These embodiments and modifications thereof are included in the scope and gist of the invention, and are included in the invention described in the claims and the equivalent scope thereof.

These embodiments can be combined as desirable by one of ordinary skill in the art. From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An antenna device, comprising:
a dielectric plate having a first surface provided with a radiation conductor and a second surface opposite to the first surface;
a conductive layer provided on the dielectric plate; and
a feeding structure for feeding the radiation conductor, wherein
when a wavelength of a radio wave transmitted or received by the radiation conductor in air is 2, and a wavelength shortening rate by the dielectric plate is k,
an outer edge of the radiation conductor has a polygonal shape in which a length of at least one side is 0.8×k×(λ/2) or more and 1.3×k×(λ/2) or less, a circular shape in which a diameter is 0.8×k×(λ/2) or more and 1.3×k×(λ/2) or less, or an elliptical shape in which a length of a major axis or a minor axis is 0.8 ×k×(λ/2) or more and 1.3×k×(λ/2) or less,
the conductive layer has an inner edge surrounding the radiation conductor such that a gap exists between inner edge and the outer edge of the radiation conductor in plan view of the dielectric plate,
the inner edge of the conductive layer has a polygonal shape in which a length of at least one side is 0.25×λ or more and 1.75×λ or less, a circular shape in which a diameter is 0.25×λ or more and 1.75×λ or less, or an elliptical shape in which a length of a major axis or a minor axis is 0.25×λ or more and 1.75×λ or less, and
a sheet resistance of the radiation conductor is equal to or less than a sheet resistance of the conductive layer.

2. The antenna device according to claim 1, wherein the sheet resistance of the radiation conductor is 0.5 [mΩ/sq] or more and 50 [Ω/sq] or less, 1 [mΩ/sq] or more and 25 [Ω/sq] or less, or 3 [mΩ/sq] or more and 5 [Ω/sq] or less.

3. The antenna device according to claim 1, wherein the sheet resistance of the conductive layer is 1 [mΩ/sq] or more and 200 [Ω/sq] or less, 3 [mΩ/sq] or more and 50 [Ω/sq] or less, or 300 [mΩ/sq] or more and 25 [Ω/sq] or less.

4. The antenna device according to claim 1, further comprising a light shielding layer formed on the first surface or the second surface,
wherein the light shielding layer has a portion overlapping the outer edge of the radiation conductor or the inner edge of the dielectric plate in plan view.

5. The antenna device according to claim 1, wherein
the conductive layer includes a first conductive layer provided on the first surface, and
the first conductive layer has a first inner edge which is the inner edge.

6. The antenna device according to claim 1, wherein
the conductive layer includes a second conductive layer provided on an inner layer of the dielectric plate, and
the second conductive layer has a second inner edge which is the inner edge.

7. The antenna device according to claim 1, wherein
the conductive layer includes a first conductive layer provided on the first surface and a second conductive layer provided on an inner layer of the dielectric plate,
the first conductive layer has a first inner edge which is the inner edge, and
the second conductive layer has a second inner edge surrounding the first inner edge such that a gap exists between the second inner edge and the first inner edge in plan view of the dielectric plate.

8. The antenna device according to claim 7, wherein the sheet resistance of the radiation conductor is lower than a sheet resistance of the first conductive layer and the second conductive layer.

9. The antenna device according to claim 1, wherein the feeding structure feeds to the radiation conductor in a non-contact manner.

10. The antenna device according to claim 1, wherein the outer edge of the radiation conductor has a square shape with a set of diagonal notches.

11. The antenna device according to claim 1, wherein the radiation conductor has a cavity formed in a central portion.
